(19) United States
(12) Patent Application Publication
(10) Pub. No.: US 2016/0197518 A1
(43) Pub. Date: Jul. 7, 2016

(54) POWER BYPASS APPARATUS AND POWER TRANSMISSION APPARATUS

(71) Applicant: DELTA ELECTRONICS, INC., Taoyuan County (TW)

(72) Inventors: Hung-Chieh LIN, Taoyuan County (TW); Chien-Chih CHAN, Taoyuan County (TW); Chia-Hung CHEN, Taoyuan County (TW); Yu-Jia CHEN, Taoyuan County (TW)

(21) Appl. No.: 14/624,667

(22) Filed: Feb. 18, 2015

(30) Foreign Application Priority Data
Jan. 6, 2015 (TW) 104100166

(51) Int. Cl. H02J 9/06

(52) U.S. Cl. CPC H02J 9/061; H02J 2009/068

(57) ABSTRACT

A power bypass apparatus includes a bypass switch circuit and a selection structure. The selection structure is electrically connected to the bypass switch circuit. A power supply apparatus sends a power through the bypass switch circuit to a power output side of a power transmission unit selected and connected by the selection structure when the bypass switch circuit is turned on.

### BACKGROUND OF THE INVENTION

1. Field of the Invention

The present invention relates to a bypass apparatus and a transmission apparatus, and especially relates to a power bypass apparatus and a power transmission apparatus.

2. Description of the Related Art

An automatic transfer switch (ATS) is an electric switch that reconnects the electric power source from its main power source to a backup power source. A power-supplying operation is transferred from the main power source to the backup power source by the automatic transfer switch so that the stable power can be continually supplied to the protected equipment when the main power source occurs abnormal operations, such as insufficient power, interruption of power supply, and so on.

The protected equipment has to receive power even if the automatic transfer switch needs to be maintained. Therefore, maintenance bypasses are turned on for connecting the protected equipment and power before the automatic transfer switch is removed for maintenance. Usually, an automatic transfer switch needs two maintenance bypasses. The more the automatic transfer switches are used, the more the maintenance bypasses are needed, so that the cost of the maintenance bypasses, the complexity of the circuit, the used space, the complexity of the operation and the maintenance time are increased.

### SUMMARY OF THE INVENTION

In order to solve the above-mentioned problems, an object of the present invention is to provide a power bypass apparatus.

In order to solve the above-mentioned problems, another object of the present invention is to provide a power transmission apparatus.

In order to achieve the object of the present invention mentioned above, the power bypass apparatus is applied to a power supply apparatus, a plurality of power transmission units and a plurality of electronic apparatuses. The power bypass apparatus is connected to the power supply apparatus, the power transmission units and the electronic apparatuses. The power bypass apparatus comprises a bypass switch circuit and a selection structure. The bypass switch circuit is connected to the power supply apparatus and the power transmission units. The selection structure is connected to the bypass switch circuit, the power transmission units and the electronic apparatuses. The selection structure selectively conducts the bypass switch circuit to one of the power transmission units and one of the electronic apparatuses. The power supply apparatus sends a power through the bypass switch circuit to the electronic apparatus and a power output side of the power transmission unit selected and connected by the selection structure when the bypass switch circuit is turned on.

In order to achieve another object of the present invention mentioned above, the power transmission apparatus is applied to a power supply apparatus and a plurality of electronic apparatuses. The power transmission apparatus is connected to the power supply apparatus and the electronic apparatuses. The power transmission apparatus comprises a bypass switch circuit, a selection structure and a plurality of power transmission units. The bypass switch circuit is connected to the power supply apparatus. The selection structure is connected to the bypass switch circuit and the electronic apparatuses. The power transmission units are connected to the bypass switch circuit, the selection structure and the electronic apparatuses. The power transmission unit comprises a power output side. The selection structure selectively conducts the bypass switch circuit to one of the power transmission units and one of the electronic apparatuses. The power supply apparatus sends a power through the bypass switch circuit to the electronic apparatus and the power output side of the power transmission unit selected and connected by the selection structure when the bypass switch circuit is turned on.

The advantage of the present invention is to use a power bypass apparatus to replace a plurality of maintenance bypasses to reduce the cost, the complexity of the circuit, the used space and the maintenance time.

### BRIEF DESCRIPTION OF DRAWING

FIG. 1 shows a block diagram of the first embodiment of the power bypass apparatus of the present invention.

FIG. 2 shows a block diagram of the second embodiment of the power bypass apparatus of the present invention.

FIG. 3 shows a block diagram of the third embodiment of the power bypass apparatus of the present invention.

FIG. 4 shows a block diagram of the power transmission apparatus of the present invention.

FIG. 5 shows another embodiment of the selection structure (or the line wire selection switch or the neutral wire selection switch) of the present invention.

### DETAILED DESCRIPTION OF THE INVENTION

Please refer to following detailed description and figures for the technical content of the present invention. The following detailed description and figures are referred for the present invention, but the present invention is not limited to it.

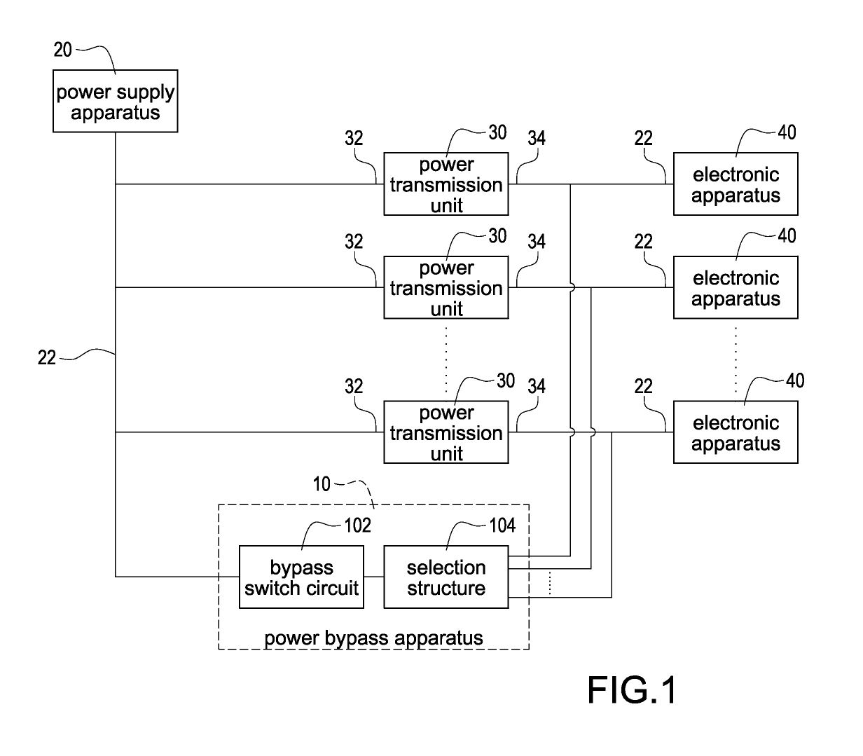

FIG. 1 shows a block diagram of the first embodiment of the power bypass apparatus of the present invention. A power bypass apparatus 10 comprises a bypass switch circuit 102 and a selection structure 104.

The power bypass apparatus 10 is applied to a power supply apparatus 20, a plurality of power transmission units 30 and a plurality of electronic apparatuses 40. The power bypass apparatus 10 is connected to the power supply apparatus 20, the power transmission units 30 and the electronic apparatuses 40. The power transmission unit 30 comprises a power input side 32 and a power output side 34. The bypass switch circuit 102 is connected to the power supply apparatus 20 and the power transmission units 30. The selection structure 104 is connected to the bypass switch circuit 102, the power transmission units 30 and the electronic apparatuses 40.

The selection structure 104 selectively conducts the bypass switch circuit 102 to one of the power transmission units 30 and one of the electronic apparatuses 40. The power supply apparatus 20 sends a power 22 through the bypass switch circuit 102 to the electronic apparatus 40 and the power output side 34 of the power transmission unit 30 which are selected and connected by the selection structure 104 when the bypass switch circuit 102 is turned on.

For example, the power supply apparatus 20 sends the power 22 through the bypass switch circuit 102 to top-down the first of the electronic apparatuses 40 in the figure and the power output side 34 of top-down the first of the power transmission units 30 in the figure when the bypass switch circuit 102 selects to connect to top-down the first of the electronic apparatuses 40 in the figure. For more example, the power supply apparatus 20 sends the power 22 through the bypass switch circuit 102 to top-down the second of the electronic apparatuses 40 in the figure and the power output side 34 of top-down the second of the power transmission units 30 in the figure when the bypass switch circuit 102 selects to connect to top-down the second of the electronic apparatuses 40 in the figure, and so on.

The power input side 32 is connected to the power supply apparatus 20. The electronic apparatus 40 is connected to the power output side 34. One side of the bypass switch circuit 102 is connected to the power supply apparatus 20 and the power input sides 32. One side of the selection structure 104 is connected to the other side of the bypass switch circuit 102. The other side of the selection structure 104 is selectively connected to one of the power output sides 34 and one of the electronic apparatuses 40.

The power supply apparatus 20 sends the power 22 through the bypass switch circuit 102 to the power output side 34 of the power transmission unit 30 and the electronic apparatus 40 which are selected and connected by the selection structure 104 to drive the electronic apparatus 40 which is selected and connected by the selection structure 104 when the bypass switch circuit 102 is turned on.

The power transmission unit 30 is, for example but not limited to, an automatic transfer switch or an uninterrupted power system. The power transmission unit 30 is used to receive the power 22, process the power 22 with the method of the automatic transfer switch and then send the power 22 to the electronic apparatus 40 to drive the electronic apparatus 40 if the power transmission unit 30 is an automatic transfer switch. The power transmission unit 30 is used to receive the power 22, process the power 22 with the method of the uninterrupted power system and then send the power 22 to the electronic apparatus 40 to drive the electronic apparatus 40 if the power transmission unit 30 is an uninterrupted power system.

The power transmission unit 30 has to be removed from the power supply apparatus 20 and the electronic apparatus 40 when the power transmission unit 30 needs maintenance. However, the electronic apparatus 40 still has to receive the power 22 even if the power transmission unit 30 is removed.

Therefore, before the power transmission unit 30 is removed, the selection structure 104 selects to connect to the power output side 34 of the power transmission unit 30 which is removed later and the electronic apparatus 40 which is connected to the power output side 34 of the power transmission unit 30 which is removed later, and then the bypass switch circuit 102 is turned on, so that the electronic apparatus 40 still receives the power 22.

The bypass switch circuit 102 is, for example but not limited to, a toggle switch. The selection structure 104 is, for example but not limited to, a multi-point change-over switch or a rotary selector switch.

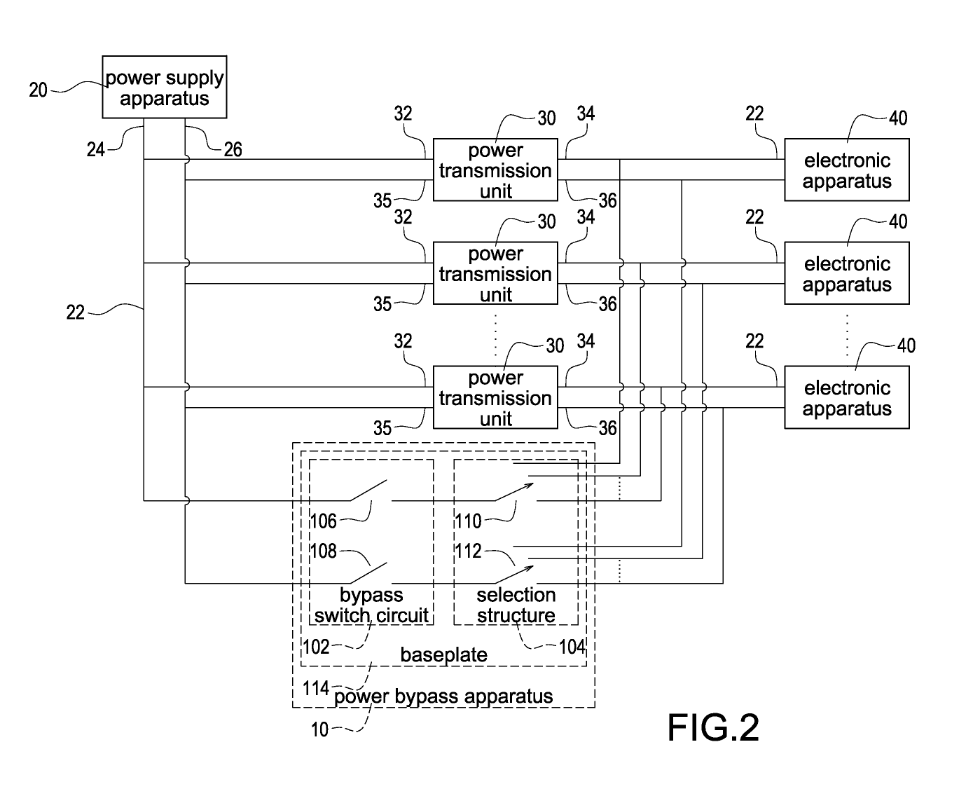

FIG. 2 shows a block diagram of the second embodiment of the power bypass apparatus of the present invention. A power bypass apparatus 10 comprises a bypass switch circuit 102, a selection structure 104 and a baseplate 114. The selection structure 104 is electrically connected to the bypass switch circuit 102. The bypass switch circuit 102 and the selection structure 104 are arranged on the baseplate 114. The baseplate 114 is used to fix the bypass switch circuit 102 and the selection structure 104, so that the power bypass apparatus 10 is more stable.

A power supply apparatus 20 sends a power 22 through the bypass switch circuit 102 to a power output side 34 of a power transmission unit 30 selected and connected by the selection structure 104 when the bypass switch circuit 102 is turned on.

The power supply apparatus 20 comprises a line wire 24 and a neutral wire 26. The bypass switch circuit 102 comprises a line wire switch 106 and a neutral wire switch 108. The line wire switch 106 is electrically connected to the line wire 24 and is arranged on the baseplate 114. The neutral wire switch 108 is electrically connected to the neutral wire 26 and is arranged on the baseplate 114.

The selection structure 104 comprises a line wire selection switch 110 and a neutral wire selection switch 112. The line wire selection switch 110 is electrically connected to the line wire switch 106 and is arranged on the baseplate 114. The neutral wire selection switch 112 is electrically connected to the neutral wire switch 108 and is arranged on the baseplate 114. The baseplate 114 is used to fix the line wire switch 106, the neutral wire switch 108, the line wire selection switch 110 and the neutral wire selection switch 112, so that the power bypass apparatus 10 is more stable.

The line wire switch 106 is used to send the power 22. The neutral wire switch 108 is used to send the power 22. The line wire selection switch 110 is used to send the power 22. The neutral wire selection switch 112 is used to send the power 22.

The power supply apparatus 20 sends the power 22 through the line wire switch 106 and the neutral wire switch 108 to the power output side 34 of the power transmission unit 30 and a neutral wire output side 36 of the power transmission unit 30 selected and connected by the line wire selection switch 110 and the neutral wire selection switch 112 when the line wire switch 106 and the neutral wire switch 108 are turned on.

In another word, the power bypass apparatus 10 is applied to the power supply apparatus 20, a plurality of the power transmission units 30 and a plurality of electronic apparatuses 40. The power transmission unit 30 comprises a power input side 32, the power output side 34, a neutral wire input side 35 and the neutral wire output side 36.

The power input side 32 is connected to the line wire 24 of the power supply apparatus 20. The neutral wire input side 35 is connected to the neutral wire 26 of the power supply apparatus 20. The electronic apparatus 40 is connected to the power output side 34 and the neutral wire output side 36.

One side of the line wire switch 106 is connected to the line wire 24 of the power supply apparatus 20 and the power input sides 32. One side of the neutral wire switch 108 is connected to the neutral wire 26 of the power supply apparatus 20 and the neutral wire input sides 35.

One side of the line wire selection switch 110 is connected to the other side of the line wire switch 106. One side of the neutral wire selection switch 112 is connected to the other side of the neutral wire switch 108. The other side of the line wire selection switch 110 is selectively connected to one of the power output sides 34 and one of the electronic apparatuses 40. The other side of the neutral wire selection switch 112 is selectively connected to one of the neutral wire output sides 36 and one of the electronic apparatuses 40.

The power supply apparatus 20 sends the power 22 through the line wire switch 106 and the neutral wire switch 108 to the power output side 34 of the power transmission unit 30, the neutral wire output side 36 of the power transmission unit 30 and the electronic apparatus 40 which are selected and connected by the line wire selection switch 110 and the neutral wire selection switch 112 to drive the electronic apparatus 40 when the line wire switch 106 and the neutral wire switch 108 are turned on.

The power transmission unit 30 is, for example but not limited to, an automatic transfer switch or an uninterrupted power system. The power transmission unit 30 is used to receive the power 22, process the power 22 with the method of the automatic transfer switch and then send the power 22 to the electronic apparatus 40 to drive the electronic apparatus 40 if the power transmission unit 30 is an automatic transfer switch. The power transmission unit 30 is used to receive the power 22, process the power 22 with the method of the uninterrupted power system and then send the power 22 to the electronic apparatus 40 to drive the electronic apparatus 40 if the power transmission unit 30 is an uninterrupted power system.

The power transmission unit 30 has to be removed from the power supply apparatus 20 and the electronic apparatus 40 when the power transmission unit 30 needs maintenance. However, the electronic apparatus 40 still has to receive the power 22 even if the power transmission unit 30 is removed.

Therefore, before the power transmission unit 30 is removed, the line wire selection switch 110 and the neutral wire selection switch 112 select to connect to the power output side 34 and the neutral wire output sides 36 of the power transmission unit 30 which is removed later, and then the line wire switch 106 and the neutral wire switch 108 are turned on, so that the electronic apparatus 40 still receives the power 22.

The line wire switch 106 is, for example but not limited to, a toggle switch. The neutral wire switch 108 is, for example but not limited to, a toggle switch. The line wire selection switch 110 is, for example but not limited to, a multi-point change-over switch or a rotary selector switch. The neutral wire selection switch 112 is, for example but not limited to, a multi-point change-over switch or a rotary selector switch.

In an embodiment, the line wire switch 106 and the neutral wire switch 108 are turned on synchronously. The power output side 34 which is selected and connected by the line wire selection switch 110 and the neutral wire output side 36 which is selected and connected by the neutral wire selection switch 112 belong to the same power transmission unit 30.

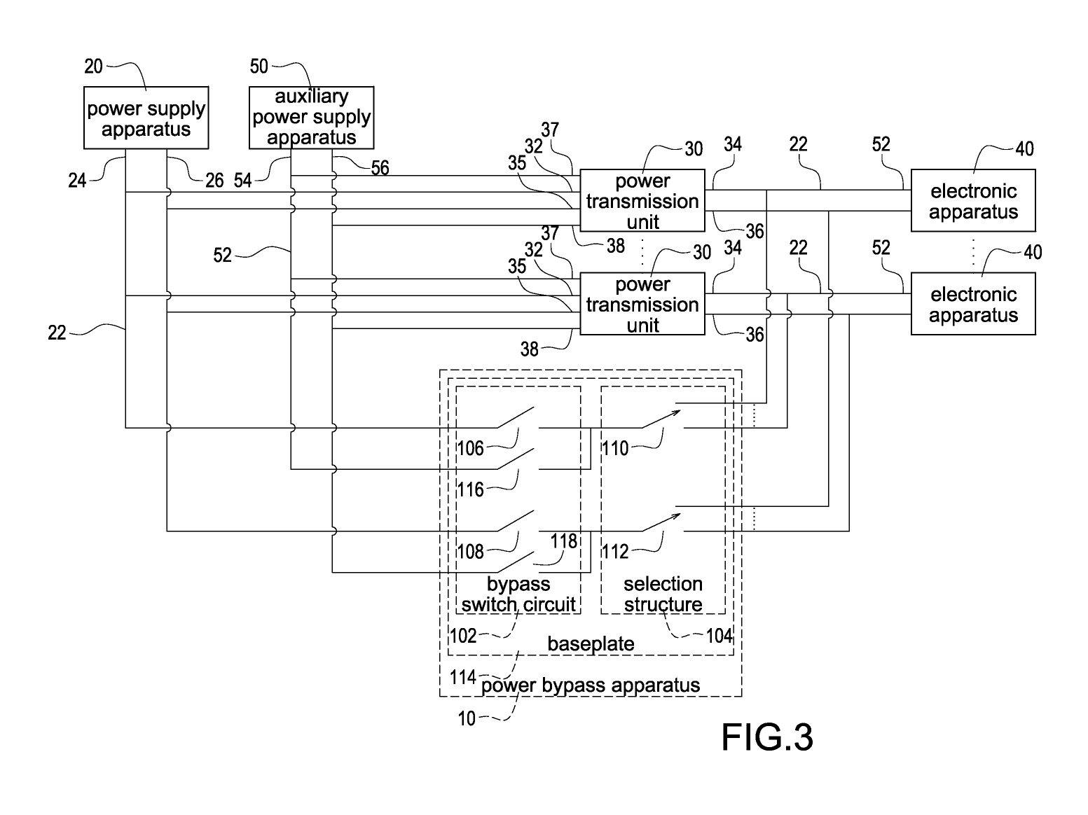

FIG. 3 shows a block diagram of the third embodiment of the power bypass apparatus of the present invention. A power bypass apparatus 10 comprises a bypass switch circuit 102, a selection structure 104 and a baseplate 114. The selection structure 104 is electrically connected to the bypass switch circuit 102. The bypass switch circuit 102 and the selection structure 104 are arranged on the baseplate 114. The baseplate 114 is used to fix the bypass switch circuit 102 and the selection structure 104, so that the power bypass apparatus 10 is more stable.

A power supply apparatus 20 sends a power 22 through the bypass switch circuit 102 to a power output side 34 and a neutral wire output side 36 of a power transmission unit 30 selected and connected by the selection structure 104 when the bypass switch circuit 102 is turned on. An auxiliary power supply apparatus 50 sends an auxiliary power 52 through the bypass switch circuit 102 to the power output side 34 and the neutral wire output side 36 of the power transmission unit 30 selected and connected by the selection structure 104 when the bypass switch circuit 102 is turned on.

The power supply apparatus 20 comprises a line wire 24 and a neutral wire 26. The auxiliary power supply apparatus 50 comprises an auxiliary line wire 54 and an auxiliary neutral wire 56. The bypass switch circuit 102 comprises a line wire switch 106, a neutral wire switch 108, an auxiliary line wire switch 116 and an auxiliary neutral wire switch 118. The selection structure 104 comprises a line wire selection switch 110 and a neutral wire selection switch 112.

The line wire switch 106 is electrically connected to the line wire 24 and is arranged on the baseplate 114. The neutral wire switch 108 is electrically connected to the neutral wire 26 and is arranged on the baseplate 114. The auxiliary line wire switch 116 is electrically connected to the auxiliary line wire 54, the line wire switch 106 and the line wire selection switch 110 and is arranged on the baseplate 114. The auxiliary neutral wire switch 118 is electrically connected to the auxiliary neutral wire 56, the neutral wire switch 108 and the neutral wire selection switch 112 and is arranged on the baseplate 114.

The line wire selection switch 110 is electrically connected to the line wire switch 106 and is arranged on the baseplate 114. The neutral wire selection switch 112 is electrically connected to the neutral wire switch 108 and is arranged on the baseplate 114. The baseplate 114 is used to fix the line wire switch 106, the neutral wire switch 108, the line wire selection switch 110, the neutral wire selection switch 112, the auxiliary line wire switch 116 and the auxiliary neutral wire switch 118, so that the power bypass apparatus 10 is more stable.

The power supply apparatus 20 sends the power 22 through the line wire switch 106 and the neutral wire switch 108 to the power output side 34 and the neutral wire output side 36 of the power transmission unit 30 selected and connected by the line wire selection switch 110 and the neutral wire selection switch 112 when the line wire switch 106 and the neutral wire switch 108 are turned on. The auxiliary power supply apparatus 50 sends the auxiliary power 52 through the auxiliary line wire switch 116 and the auxiliary neutral wire switch 118 to the power output side 34 and the neutral wire output side 36 of the power transmission unit 30 selected and connected by the line wire selection switch 110 and the neutral wire selection switch 112 when the auxiliary line wire switch 116 and the auxiliary neutral wire switch 118 are turned on.

In another word, the power bypass apparatus 10 is applied to the power supply apparatus 20, a plurality of the power transmission units 30, a plurality of electronic apparatuses 40 and the auxiliary power supply apparatus 50. The power transmission unit 30 comprises a power input side 32, the power output side 34, a neutral wire input side 35, the neutral wire output side 36, an auxiliary line wire input side 37 and an auxiliary neutral wire input side 38.

The power input side 32 is connected to the line wire 24 of the power supply apparatus 20. The neutral wire input side 35 is connected to the neutral wire 26 of the power supply apparatus 20. The auxiliary line wire input side 37 is connected to the auxiliary line wire 54 of the auxiliary power supply apparatus 50. The auxiliary neutral wire input side 38 is connected to the auxiliary neutral wire 56 of the auxiliary power supply apparatus 50. The electronic apparatus 40 is connected to the power output side 34 and the neutral wire output side 36.

One side of the line wire switch 106 is connected to the line wire 24 of the power supply apparatus 20 and the power input sides 32. One side of the neutral wire switch 108 is connected to the neutral wire 26 of the power supply apparatus 20 and the neutral wire input sides 35. One side of the auxiliary line wire switch 116 is connected to the auxiliary line wire 54 of the auxiliary power supply apparatus 50 and the auxiliary line wire input sides 37. One side of the auxiliary neutral wire switch 118 is connected to the auxiliary neutral wire 56 of the auxiliary power supply apparatus 50 and the auxiliary neutral wire input sides 38.

One side of the line wire selection switch 110 is connected to the other side of the line wire switch 106 and the other side of the auxiliary line wire switch 116. One side of the neutral wire selection switch 112 is connected to the other side of the neutral wire switch 108 and the other side of the auxiliary neutral wire switch 118. The other side of the line wire selection switch 110 is selectively connected to one of the power output sides 34 and one of the electronic apparatuses 40. The other side of the neutral wire selection switch 112 is selectively connected to one of the neutral wire output sides 36 and one of the electronic apparatuses 40.

The line wire switch 106 is used to send the power 22. The neutral wire switch 108 is used to send the power 22. The line wire selection switch 110 is used to send the power 22. The neutral wire selection switch 112 is used to send the power 22. The auxiliary line wire switch 116 is used to send the auxiliary power 52. The auxiliary neutral wire switch 118 is used to send the auxiliary power 52. The line wire selection switch 110 is used to send the auxiliary power 52. The neutral wire selection switch 112 is used to send the auxiliary power 52.

The power supply apparatus 20 sends the power 22 through the line wire switch 106 and the neutral wire switch 108 to the power output side 34 of the power transmission unit 30, the neutral wire output side 36 of the power transmission unit 30 and the electronic apparatus 40 which are selected and connected by the line wire selection switch 110 and the neutral wire selection switch 112 to drive the electronic apparatus 40 when the line wire switch 106 and the neutral wire switch 108 are turned on.

The auxiliary power supply apparatus 50 sends the auxiliary power 52 through the auxiliary line wire switch 116 and the auxiliary neutral wire switch 118 to the power output side 34 of the power transmission unit 30, the neutral wire output side 36 of the power transmission unit 30 and the electronic apparatus 40 which are selected and connected by the line wire selection switch 110 and the neutral wire selection switch 112 to drive the electronic apparatus 40 when the auxiliary line wire switch 116 and the auxiliary neutral wire switch 118 are turned on.

The power transmission unit 30 is, for example but not limited to, an automatic transfer switch or an uninterrupted power system. The power transmission unit 30 is used to receive the power 22 and the auxiliary power 52, process the power 22 and the auxiliary power 52 with the method of the automatic transfer switch and then send the power 22 and the auxiliary power 52 to the electronic apparatus 40 to drive the electronic apparatus 40 if the power transmission unit 30 is an automatic transfer switch. The power transmission unit 30 is used to receive the power 22 and the auxiliary power 52, process the power 22 and the auxiliary power 52 with the method of the uninterrupted power system and then send the power 22 and the auxiliary power 52 to the electronic apparatus 40 to drive the electronic apparatus 40 if the power transmission unit 30 is an uninterrupted power system.

The power transmission unit 30 has to be removed from the power supply apparatus 20, the electronic apparatus 40 and the auxiliary power supply apparatus 50 when the power transmission unit 30 needs maintenance. However, the electronic apparatus 40 still has to receive the power 22 or the auxiliary power 52 even if the power transmission unit 30 is removed.

Therefore, before the power transmission unit 30 is removed, the line wire selection switch 110 and the neutral wire selection switch 112 select to connect to the power output side 34 and the neutral wire output side 36 of the power transmission unit 30 which is removed later, and then the line wire switch 106 and the neutral wire switch 108 are turned on, so that the electronic apparatus 40 still receives the power 22.

Before the power transmission unit 30 is removed, the line wire selection switch 110 and the neutral wire selection switch 112 select to connect to the power output side 34 and the neutral wire output side 36 of the power transmission unit 30 which is removed later, and then the auxiliary line wire switch 116 and the auxiliary neutral wire switch 118 are turned on, so that the electronic apparatus 40 still receives the auxiliary power 52.

The line wire switch 106 is, for example but not limited to, a toggle switch. The neutral wire switch 108 is, for example but not limited to, a toggle switch. The auxiliary line wire switch 116 is, for example but not limited to, a toggle switch. The auxiliary neutral wire switch 118 is, for example but not limited to, a toggle switch. The line wire selection switch 110 is, for example but not limited to, a multi-point change-over switch or a rotary selector switch. The neutral wire selection switch 112 is, for example but not limited to, a multi-point change-over switch or a rotary selector switch.

In an embodiment, the line wire switch 106, the neutral wire switch 108, the auxiliary line wire switch 116 and the auxiliary neutral wire switch 118 are turned on synchronously. The power output side 34 which is selected and connected by the line wire selection switch 110 and the neutral wire output side 36 which is selected and connected by the neutral wire selection switch 112 belong to the same power transmission unit 30.

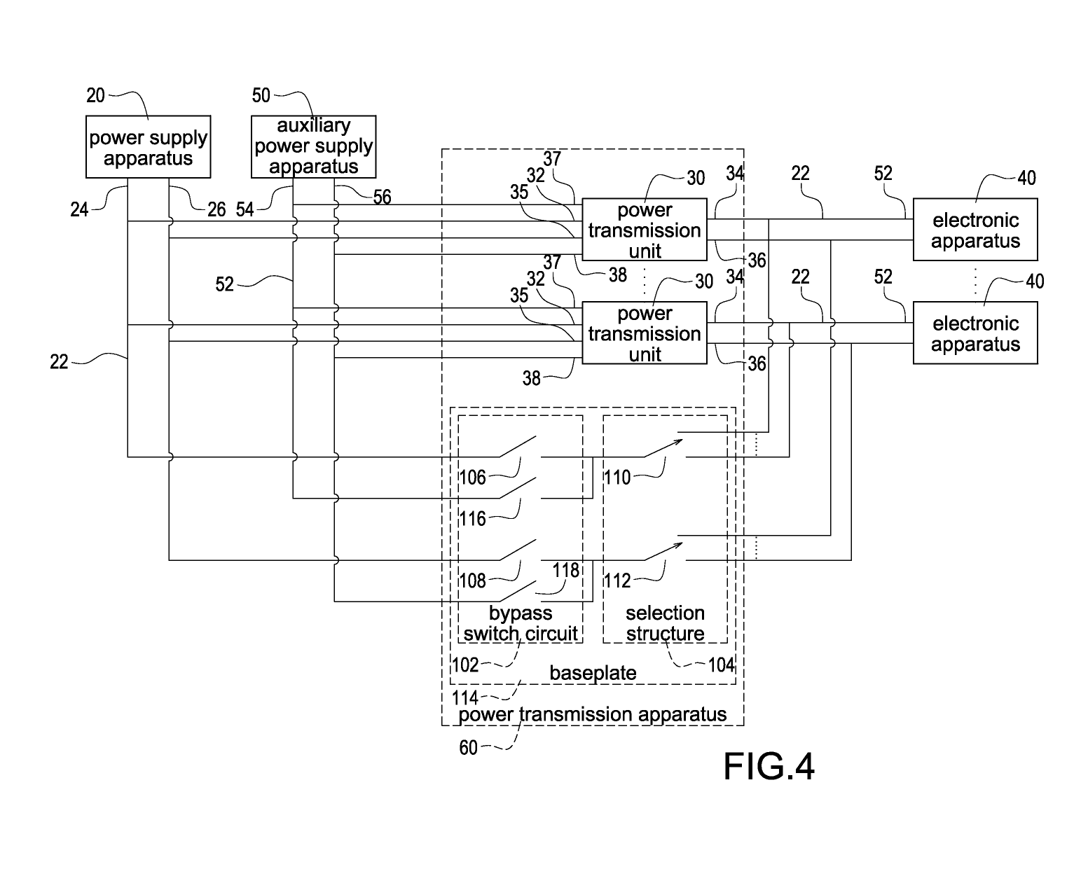

FIG. 4 shows a block diagram of the power transmission apparatus of the present invention. A power transmission apparatus 60 is applied to a power supply apparatus 20, an auxiliary power supply apparatus 50 and a plurality of electronic apparatuses 40. The power transmission apparatus 60 is connected to the power supply apparatus 20, the auxiliary power supply apparatus 50 and the electronic apparatuses 40. The power transmission apparatus 60 comprises a bypass switch circuit 102, a selection structure 104 and a plurality of power transmission units 30.

The bypass switch circuit 102 is connected to the power supply apparatus 20 and the auxiliary power supply apparatus 50. The selection structure 104 is connected to the bypass switch circuit 102 and the electronic apparatuses 40. The power transmission units 30 are connected to the bypass switch circuit 102, the selection structure 104, the power supply apparatus 20, the auxiliary power supply apparatus 50 and the electronic apparatuses 40. The power transmission unit 30 comprises a power output side 34 and a neutral wire output side 36.

The selection structure 104 selectively conducts the bypass switch circuit 102 to one of the power transmission units 30 and one of the electronic apparatuses 40. The power supply apparatus 20 sends a power 22 through the bypass switch circuit 102 to the electronic apparatus 40 and the power output side 34 and the neutral wire output side 36 of the power transmission unit 30 selected and connected by the selection structure 104 when the bypass switch circuit 102 is turned on. The auxiliary power supply apparatus 50 sends an auxiliary power 52 through the bypass switch circuit 102 to the power output side 34 and the neutral wire output side 36 of the power transmission unit 30 selected and connected by the selection structure 104 when the bypass switch circuit 102 is turned on.

The power supply apparatus 20 comprises a line wire 24 and a neutral wire 26. The auxiliary power supply apparatus 50 comprises an auxiliary line wire 54 and an auxiliary neutral wire 56. The bypass switch circuit 102 comprises a line wire switch 106, a neutral wire switch 108, an auxiliary line wire switch 116 and an auxiliary neutral wire switch 118. The selection structure 104 comprises a line wire selection switch 110 and a neutral wire selection switch 112.

The line wire switch 106 is electrically connected to the line wire 24. The neutral wire switch 108 is electrically connected to the neutral wire 26. The line wire selection switch 110 is electrically connected to the line wire switch 106. The neutral wire selection switch 112 is electrically connected to the neutral wire switch 108. The auxiliary line wire switch 116 is electrically connected to the auxiliary line wire 54 of the auxiliary power supply apparatus 50, the line wire switch 106 and the line wire selection switch 110. The auxiliary neutral wire switch 118 is electrically connected to the auxiliary neutral wire 56 of the auxiliary power supply apparatus 50, the neutral wire switch 108 and the neutral wire selection switch 112.

The line wire switch 106 is used to send the power 22. The neutral wire switch 108 is used to send the power 22. The line wire selection switch 110 is used to send the power 22. The neutral wire selection switch 112 is used to send the power 22. The auxiliary line wire switch 116 is used to send the auxiliary power 52. The auxiliary neutral wire switch 118 is used to send the auxiliary power 52. The line wire selection switch 110 is used to send the auxiliary power 52. The neutral wire selection switch 112 is used to send the auxiliary power 52. The power supply apparatus 20 sends the power 22 through the line wire switch 106 and the neutral wire switch 108 to the power output side 34 and the neutral wire output side 36 of the power transmission unit 30 selected and connected by the line wire selection switch 110 and the neutral wire selection switch 112 when the line wire switch 106 and the neutral wire switch 108 are turned on.

The auxiliary power supply apparatus 50 sends the auxiliary power 52 through the auxiliary line wire switch 116 and the auxiliary neutral wire switch 118 to the power output side 34 and the neutral wire output side 36 of the power transmission unit 30 selected and connected by the line wire selection switch 110 and the neutral wire selection switch 112 when the auxiliary line wire switch 116 and the auxiliary neutral wire switch 118 are turned on.

The line wire switch 106 is, for example but not limited to, a toggle switch. The auxiliary line wire switch 116 is, for example but not limited to, a toggle switch. The neutral wire switch 108 is, for example but not limited to, a toggle switch. The auxiliary neutral wire switch 118 is, for example but not limited to, a toggle switch. The line wire selection switch 110 is, for example but not limited to, a multi-point change-over switch or a rotary selector switch. The neutral wire selection switch 112 is, for example but not limited to, a multi-point change-over switch or a rotary selector switch. Moreover, the description for the elements shown in FIG. 4, which are similar to those shown in FIG. 3, is not repeated here for brevity.

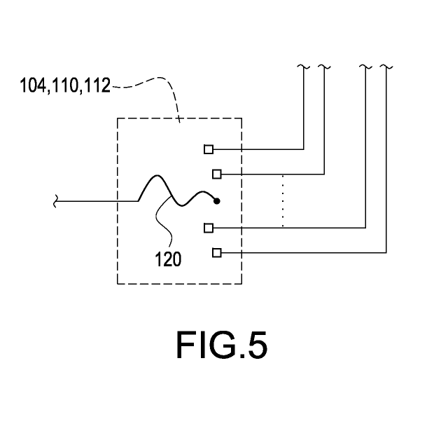

FIG. 5 shows another embodiment of the selection structure (or the line wire selection switch or the neutral wire selection switch) of the present invention. The selection structure 104 (or the line wire selection switch 110 or the neutral wire selection switch 112) comprises a connecting wire 120 for connecting to the power output side 34 (or the neutral wire output side 36) of the power transmission unit 30 and the electronic apparatus 40 which are selected and connected.

The advantage of the present invention is to use a power bypass apparatus to replace a plurality of maintenance bypasses to reduce the cost, the complexity of the circuit, the used space and the maintenance time.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power bypass apparatus applied to a power supply apparatus, a plurality of power transmission units and a plurality of electronic apparatuses, the power bypass apparatus connected to the power supply apparatus, the power transmission units and the electronic apparatuses, the power bypass apparatus comprising:
a bypass switch circuit connected to the power supply apparatus and the power transmission units; and
a selection structure connected to the bypass switch circuit, the power transmission units and the electronic apparatuses,
wherein the selection structure selectively conducts the bypass switch circuit to one of the power transmission units and one of the electronic apparatuses;
wherein the power supply apparatus sends a power through the bypass switch circuit to the electronic apparatus and a power output side of the power transmission unit selected and connected by the selection structure when the bypass switch circuit is turned on.

2. The power bypass apparatus in claim 1, wherein the power supply apparatus comprises a line wire; the bypass switch circuit comprises a line wire switch electrically connected to the line wire; the line wire switch is used to send the power.

3. The power bypass apparatus in claim 2, wherein the power supply apparatus further comprises a neutral wire; the bypass switch circuit further comprises a neutral wire switch electrically connected to the neutral wire; the neutral wire switch is used to send the power.

4. The power bypass apparatus in claim 3, wherein the selection structure comprises a line wire selection switch electrically connected to the line wire switch; the line wire selection switch is used to send the power.

5. The power bypass apparatus in claim 4, wherein the selection structure further comprises a neutral wire selection switch electrically connected to the neutral wire switch; the neutral wire selection switch is used to send the power; the power supply apparatus sends the power through the line wire switch and the neutral wire switch to the power output side of the power transmission unit selected and connected by the line wire selection switch and the neutral wire selection switch when the line wire switch and the neutral wire switch are turned on.

6. The power bypass apparatus in claim 5, wherein the bypass switch circuit further comprises an auxiliary line wire switch electrically connected to an auxiliary line wire of an auxiliary power supply apparatus, the line wire switch and the line wire selection switch; the auxiliary line wire switch is used to send an auxiliary power.

7. The power bypass apparatus in claim 6, wherein the bypass switch circuit further comprises an auxiliary neutral wire switch electrically connected to an auxiliary neutral wire of the auxiliary power supply apparatus, the neutral wire switch and the neutral wire selection switch; the auxiliary power supply apparatus sends the auxiliary power through the auxiliary line wire switch and the auxiliary neutral wire switch to the power output side of the power transmission unit selected and connected by the line wire selection switch and the neutral wire selection switch when the auxiliary line wire switch and the auxiliary neutral wire switch are turned on.

8. The power bypass apparatus in claim 7, wherein the line wire switch is a toggle switch; the auxiliary line wire switch is a toggle switch.

9. The power bypass apparatus in claim 8, wherein the neutral wire switch is a toggle switch; the auxiliary neutral wire switch is a toggle switch.

10. The power bypass apparatus in claim 9, wherein the line wire selection switch is a multi-point change-over switch or a rotary selector switch; the neutral wire selection switch is a multi-point change-over switch or a rotary selector switch.

11. A power transmission apparatus applied to a power supply apparatus and a plurality of electronic apparatuses, the power transmission apparatus connected to the power supply apparatus and the electronic apparatuses, the power transmission apparatus comprising:
a bypass switch circuit connected to the power supply apparatus;
a selection structure connected to the bypass switch circuit and the electronic apparatuses; and
a plurality of power transmission units connected to the bypass switch circuit, the selection structure and the electronic apparatuses, the power transmission unit comprising a power output side,
wherein the selection structure selectively conducts the bypass switch circuit to one of the power transmission units and one of the electronic apparatuses;
wherein the power supply apparatus sends a power through the bypass switch circuit to the electronic apparatus and the power output side of the power transmission unit selected and connected by the selection structure when the bypass switch circuit is turned on.

12. The power transmission apparatus in claim 11, wherein the power supply apparatus comprises a line wire; the bypass switch circuit comprises a line wire switch electrically connected to the line wire; the line wire switch is used to send the power.

13. The power transmission apparatus in claim 12, wherein the power supply apparatus further comprises a neutral wire; the bypass switch circuit further comprises a neutral wire switch electrically connected to the neutral wire; the neutral wire switch is used to send the power.

14. The power transmission apparatus in claim 13, wherein the selection structure comprises a line wire selection switch electrically connected to the line wire switch; the line wire selection switch is used to send the power.

15. The power transmission apparatus in claim 14, wherein the selection structure further comprises a neutral wire selection switch electrically connected to the neutral wire switch; the neutral wire selection switch is used to send the power; the power supply apparatus sends the power through the line wire switch and the neutral wire switch to the power output side of the power transmission unit selected and connected by the line wire selection switch and the neutral wire selection switch when the line wire switch and the neutral wire switch are turned on.

16. The power transmission apparatus in claim 15, wherein the bypass switch circuit further comprises an auxiliary line wire switch electrically connected to an auxiliary line wire of an auxiliary power supply apparatus, the line wire switch and the line wire selection switch; the auxiliary line wire switch is used to send an auxiliary power.

17. The power transmission apparatus in claim 16, wherein the bypass switch circuit further comprises an auxiliary neutral wire switch electrically connected to an auxiliary neutral wire of the auxiliary power supply apparatus, the neutral wire switch and the neutral wire selection switch; the auxiliary power supply apparatus sends the auxiliary power through the auxiliary line wire switch and the auxiliary neutral wire switch to the power output side of the power transmission unit selected and connected by the line wire selection switch and the neutral wire selection switch when the auxiliary line wire switch and the auxiliary neutral wire switch are turned on.

18. The power transmission apparatus in claim 17, wherein the line wire switch is a toggle switch; the auxiliary line wire switch is a toggle switch.

19. The power transmission apparatus in claim 18, wherein the neutral wire switch is a toggle switch; the auxiliary neutral wire switch is a toggle switch.

20. The power transmission apparatus in claim 19, wherein the line wire selection switch is a multi-point change-over switch or a rotary selector switch; the neutral wire selection switch is a multi-point change-over switch or a rotary selector switch.
